(19) United States
(12) Patent Application Publication
(10) Pub. No.: US 2005/0080684 A1
(43) Pub. Date: Apr. 14, 2005

(54) Digital content and product ordering apparatus and method

(76) Inventor: Scott Blum, Jackson, WY (US)

Correspondence Address: Mitchell P. Brook, Esq., Suite 200, 11988 El Camino Real, San Diego, CA, 92130, US

(21) Appl. No.: 10/736,800

(22) Filed: Dec. 15, 2003

Related U.S. Application Data
(60) Provisional application No. 60/510,632, filed on Oct. 10, 2003.

(51) Int. Cl. G06F 17/60

(52) U.S. Cl. 705/26

(57) ABSTRACT

A method and apparatus for ordering products using an editorial content provider. The editorial content is displayed to the user preferably as an electronic magazine. The electronic magazine includes magazine page numbers and navigation controls that enable a user to browse the electronic magazine in a manner similar to a conventional paper magazine. The editorial content includes user selectable links to products identified in the editorial content. A user may select the user selectable link and be presented with a product purchase page associated with the product identified in the editorial content. The product purchase page enables the user to place an order for the product. A third-party product supplier may present the product purchase page.

### CROSS REFERENCE TO RELATED APPLICATIONS

This application claims priority to Provisional Patent Application Ser. No. 60/510,632, filed on Oct. 10, 2003, the contents of which are incorporated herein by reference.

### FIELD OF THE INVENTION

The present invention relates to an apparatus and method of conducting commercial transactions and presenting editorial content.

### BACKGROUND OF THE INVENTION

On-line commerce is a growing field with specialized Internet retailers such as Buy.Com and Internet websites of brick and mortar retailers, such as Macys.com vying for consumer traffic and sales. Frequently such websites enable consumers to browse or search products and services and place orders for items selected. Searching for the desired product sometimes involves browsing lists of hits, clicking for further information, from various search “hits” until a desired product is located. In the description that follows, “product” will mean any product, service or any other item that is offered for sale.

Consumers also can learn about specific products via advertising in various media or through informational articles, such as in magazines or newspapers. For example, a consumer may read an article about a new or recommended product that the consumer wishes to purchase. The article may be published on-line and/or in print. If the article is published on-line, the consumer must go to an on-line commerce website, and then undergo the searching or browsing processes to locate and order the product desired.

Although these forms of on-line commerce service have been successful and popular with consumers, there are certain disadvantages associated with them. For example, searching and browsing “hits” can be time consuming and involve numerous mouse clicks to scroll, view product description pages, click back, and view other product description pages, until a desired product is selected for purchase. This form of shopping can be time consuming and difficult particularly when sorting through numerous products.

Websites providing editorial content are also known. Examples of websites providing editorial content include Cnn.Com, Foxnews.Com, Slate.Com, Usnews.Com and Time.Com and so on. Some of these are on-line versions of print publications and others are primarily Internet-sourced content providers. The websites that provide editorial content are typically on-line electronic versions of print publications. At times these websites have provided editorial content directed or referring to or reviewing a products. Although such editorial content can highlight specific products, these websites suffer disadvantages in making purchasing such products cumbersome in necessitating travel to other websites locations and services—typically requiring the searching/browsing shopping process.

Another disadvantage of on-line versions of print publications is that the on-line versions typically lack the format of the print version. For example, the on-line version of a magazine or newspaper typically fails to reproduce in the html web-page the format of the printed magazine or newspaper, such as the page corner pagination, center crease, face-to-face page display (i.e. two pages displayed at one time, on either side of the center fold), easy turning to subsequent pages from earlier pages by looking for the desired page numbers, advertising copy interspersed with the text, such as on facing pages on opposite sides of a center crease, back cover advertising, and front cover graphics. These shortcomings lead to the disadvantage that a reader of a print-type publication may be familiar with and prefer a layout of a print version of the publication, however, when viewing the on-line version, the reader must search on-line for each desired article or section and then determine how to access and locate the desired section.

Accordingly, there is a need for an on-line editorial content provider that provides on-line electronic editorial content in the familiar print version format, and preferably intersperses advertising with the print format to resemble a magazine or newspaper, and further promotes commercial transactions with easy linkage to product order pages.

### SUMMARY OF THE INVENTION

The present invention alleviates to a great extent the disadvantages of known on-line editorial content and on-line commerce providers by providing a shopping experience with editorial content.

The editorial content may be, for example, an on-line magazine, catalog, newspaper or other publication. Preferably, the editorial content is displayed in an electronic format that presents an experience to a reader that is similar to an experience of reading a printed magazine, newspaper or catalog.

In a preferred embodiment, the editorial content is displayed on a display device such as a computer monitor two pages at a time, side-by-side, and separated by a divider to simulate a bound book appearance (i.e. a center crease). The display optionally can include a page number indicator corresponding to a print page number of a print format of the editorial content and next page and previous page selectors.

The reader can navigate through the editorial content in a manner that simulates page-turning that may be performed by a reader of a print version of the editorial content. For example the reader can turn pages by clicking on the next or previous page indicators, or can jump pages by entering a desired page number or page number increment.

An enhanced advertising or shopping experience also is optionally combined with the reading experience. For example, the editorial content optionally includes product links provided within the editorial content. Clicking a product link can produce display of a product information page relating to the particular product discussed in the editorial content. Other options are direct links to product purchase pages, product check out pages, and lists of similar products of interest. These can be displayed via pop-ups, or replacement displays or any other display technique that displays the desired product page. Such product links within the editorial content enable a reader to request a product page associated with the product that is identified in the editorial content. The product links may be provided in, for example, an article of the editorial content, or alternatively in an ad. After a reader selects a link, a product page associated with that product link may be presented to the reader. The product page may enable the reader to submit an order for the product. Alternatively, the product page may include a link to a product purchase page that enables the reader to input purchase information for submitting an order for the product.

According to one embodiment, an electronic commerce server of an on-line commerce website presents the product page and/or product purchase pages to the reader. The electronic commerce server transmits the product page to a device used by the reader. The device displays the product page to the reader. Alternatively, the on-line magazine server or other server providing the editorial content may present the product page(s) to the reader.

The editorial content may include an editorial content table of contents and a shopping table of contents. The editorial content table of contents may include links to, for example, articles or other features of the editorial content. The shopping table of contents may also include links to shopping related portions of the editorial content. After selecting a link in the shopping table of contents, the reader may be presented with one or more pages of products within that category that may be available for purchase. Preferably, a table of contents link is provided on each page of the editorial content that enables the reader to cause the table of contents page to be presented to the reader.

A section locator may also be provided. One or more sections may be provided in the editorial content. The section may be shopping categories or features of the editorial content. A display corresponding to a beginning page (if more than one page is associated with that section) of that section may be presented to the reader. Preferably, each page associated with that section includes a section heading identifying the section.

A Go to page receiving field is preferably presented on each page of the editorial content. The Go to page receiving field enables a reader to insert a particular page number and request that the editorial content associated with that page number be presented to the reader. The reader may request the particular page by selecting a Go icon or by another input mechanism. The particular page number preferably corresponds to a page number of a print version of the editorial content. If the reader enters a page number from a print version of a publication into the Go to page receiving field, editorial content provided on that page of the print version is presented to the reader in electronic form.

According to one embodiment, the display may include a folded view option. The reader may select the folded view option to present the reader with a display that simulates a folded magazine or other publication. This provides the reader with an experience similar to folding-over a bound publication about a center or bound portion to view only one page of the publication.

These and other features and advantages of the present invention will be appreciated from review of the following detailed description of the invention, along with the accompanying figures in which like reference numerals refer to like parts throughout.

### BRIEF DESCRIPTION OF THE DRAWINGS

FIG. 1 is a flow diagram associated with a server system in accordance with an embodiment of the present invention;

FIG. 2 is a flow diagram associated with a server system in accordance with an embodiment of the present invention;

FIG. 3 is a flow diagram of operation of client software in accordance with an embodiment of the present invention;

FIG. 4 is a flow diagram of operation of client software in accordance with an embodiment of the present invention;

FIG. 5 is a flow diagram associated with a server system in accordance with an embodiment of the present invention;

FIG. 6 is a flow diagram of operation of client software in accordance with an embodiment of the present invention;

FIG. 7 is a flow diagram of user input in accordance with an embodiment of the present invention;

FIG. 8 is a block diagram of a server system in accordance with an embodiment of the present invention;

FIG. 9 is a block diagram of operation of client software in accordance with an embodiment of the present invention;

FIG. 10 is a block diagram of a server system in accordance with an embodiment of the present invention;

FIG. 11 is a block diagram of operation of client software in accordance with an embodiment of the present invention;

FIG. 12 is a block diagram of another aspect of a server system in accordance with an embodiment of the present invention;

FIG. 13 is a block diagram of operation of client software in accordance with an embodiment of the present invention;

FIG. 14 is a block diagram of user input in accordance with an embodiment of the present invention;

FIG. 15 is a system diagram of a typical client system in accordance with an embodiment of the present invention;

FIG. 16 is a system diagram of a typical client system in accordance with an embodiment of the present invention.

FIG. 17 is a display screen representation showing a welcome display of a client system in accordance with an embodiment of the present invention;

FIG. 18 is a display screen representation showing a front page display of a client system in accordance with an embodiment of the present invention; and

FIG. 19 is a display screen representation showing an inside page display of a client system in accordance with an embodiment of the present invention.

### DETAILED DESCRIPTION OF THE INVENTION

In the following paragraphs, the present invention will be described in detail by way of example with reference to the accompanying drawings. Throughout this description, the preferred embodiments and examples shown should be considered as exemplars, rather than as limitations on the present invention. As used herein, the “present invention” refers to any one of the embodiments of the invention described herein, and any equivalents. Furthermore, reference to various aspects of the invention throughout this document does not mean that all claimed embodiments or methods must include the referenced aspects.

In accordance with the present invention, a system is provided for presenting editorial content that is combined with a shopping experience. The editorial content may be, for example, an on-line magazine, catalog, newspaper or other publication. Preferably, the editorial content is displayed in an electronic format that presents an experience to a reader that is similar to an experience of reading a print format version of the editorial content, such as a printed magazine, newspaper, catalog, newsletter or other printed publication. For example, the editorial content may be displayed on a display device such as a computer monitor two pages at a time, side-by-side, and separated by a divider to simulate a bound book appearance. The display may also include a page number indicator corresponding to a print page number of a print format of the editorial content and next page and previous page selectors.

A reader may navigate through the editorial content using, for example, the next page and previous page selectors. Upon selecting either a next page or previous page selector, a corresponding display may be presented to the user. For example, if a user selects a next page selector, the display may present the following two pages of editorial content and increment the page number indicator by two. This simulates page turning that may be performed by a reader of a print version of the editorial content.

The editorial content may include an editorial content table of contents and a shopping table of contents. The editorial content table of contents may include links to, for example, articles or other features of the editorial content. The reader may select a link in the editorial content table of contents that causes a display that is associated with that link to be presented to the reader. The shopping table of contents may also include links to shopping related portions of the editorial content. For example, the shopping table of contents may include links to shopping categories. The shopping categories may be, for example, movies, books, music, games, sports, electronics, computers, audio and video, etc. After selecting a link in the shopping table of contents, the reader may be presented with one or more pages of products within that category that may be available for purchase. Preferably, a table of contents link is provided on each page of the editorial content that enables the reader to cause the table of contents page to be presented to the reader.

A section locator may also be provided. The section locator may be presented as a pull-down menu, a section list with corresponding radio buttons, hypertext links or other selector. The sections may be shopping categories or features of the editorial content. The reader may select a section using, for example, any known input mechanism such as a computer keyboard or mouse, voice recognition software, touch-screen, light pen, etc. A display corresponding to a beginning page (if more than one page is associated with that section) of that section may be presented to the reader. Preferably, each page associated with that section includes a section heading identifying the section. According to one embodiment, the section locator is presented on every page of the editorial content.

A Go to page receiving field is preferably presented on each page of the editorial content. The Go to page receiving field enables a reader to insert a particular page number and request that the editorial content associated with that page number be presented to the reader. The reader may request the particular page by selecting a Go icon or by another input mechanism. The particular page number preferably corresponds to a page number of a print version of the editorial content. For example, the editorial content may be an electronic version of the print version of People Magazine. If the reader enters a page number from the print version of People Magazine into the Go to page receiving field, editorial content provided on that page of the print version is presented to the reader in electronic form.

According to one embodiment, the display may include a folded view option. The reader may select the folded view option to present the reader with a display that simulates a folded magazine or other publication. For example, the reader may select a folded view option and be presented with a display of only one page of the editorial content. This provides the reader with an experience similar to folding-over a bound publication about a center or bound portion to view only one page of the publication. Preferably, the folded view option is presented with each display of the editorial content.

The editorial content may also include product links provided within the editorial content. The product links enable a reader to submit an order for a product that is identified in the editorial content. The product links may be provided in, for example, an article of the editorial content. For example, the reader may desire to purchase a product identified the editorial content. A link to a product page for that product may be included within the editorial content. The reader may select the link using any known mechanism. A product page may then be presented to the reader. The product page may include a description of the product and enable the reader to submit an order for the product. Alternatively, the product page may include a link to a product purchase page that enables the reader to input purchase information for submitting an order for the product.

According to one embodiment, an electronic commerce server of a product supplier presents the product page and/or product purchase pages to the reader. For example, upon selecting the product link, a product page request is transmitted to the electronic commerce server instead of an on-line magazine server or other server presenting the editorial content. The electronic commerce server transmits the product page to a device used by the reader. The device displays the product page to the reader. Alternatively, the on-line magazine server or other server providing the editorial content may present the product page(s) to the reader.

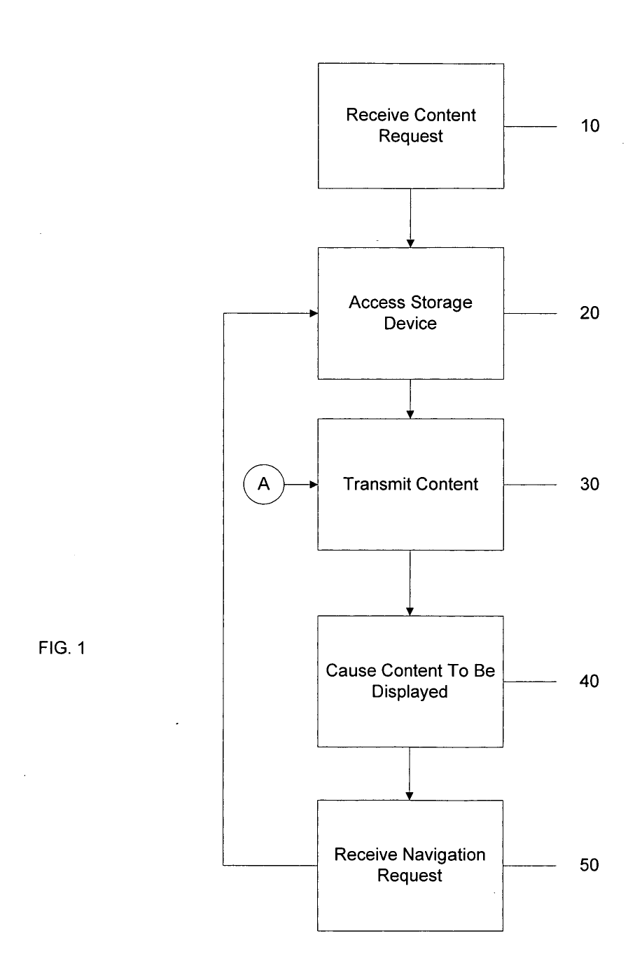

FIG. 1 illustrates a method of ordering a product using an editorial content provider according to one embodiment of the present invention. A server of an editorial content provider may receive a request for editorial content from a device operated by a user in step 10. The editorial content provider may be, for example, an on-line magazine, newspaper, catalog, or other publication. The user may be, for example, a person using a client device such as a desktop computer, laptop computer, web-enabled mobile phone or personal digital assistant or other device enabling access to the Internet. The server accesses a storage device in step 20 that stores the editorial content requested. The storage device may be, for example, a database or data warehouse, random access memory, hard-disc, soft-disc or other type of storage device. The server then transmits the editorial content 30 to the user's device. In step 40, the server causes the editorial content to be displayed on the user's device.

The display may include one or more navigation controls that enable the user to navigate the editorial content. For example, the navigation controls may include next page and previous page that operate to simulate page-turning as in a conventional bound publication, specific page locators, section locators, table of contents links, and other navigation controls all of which are described in further detail below. The server may receive a navigation request from the user in step 50. The navigation request may cause the server to transmit particular editorial content that satisfies the navigation request. Upon receiving the navigation request, the server may access the storage device storing the editorial content as in step 20. The editorial content satisfying the navigation request may then be transmitted to the user in step 30.

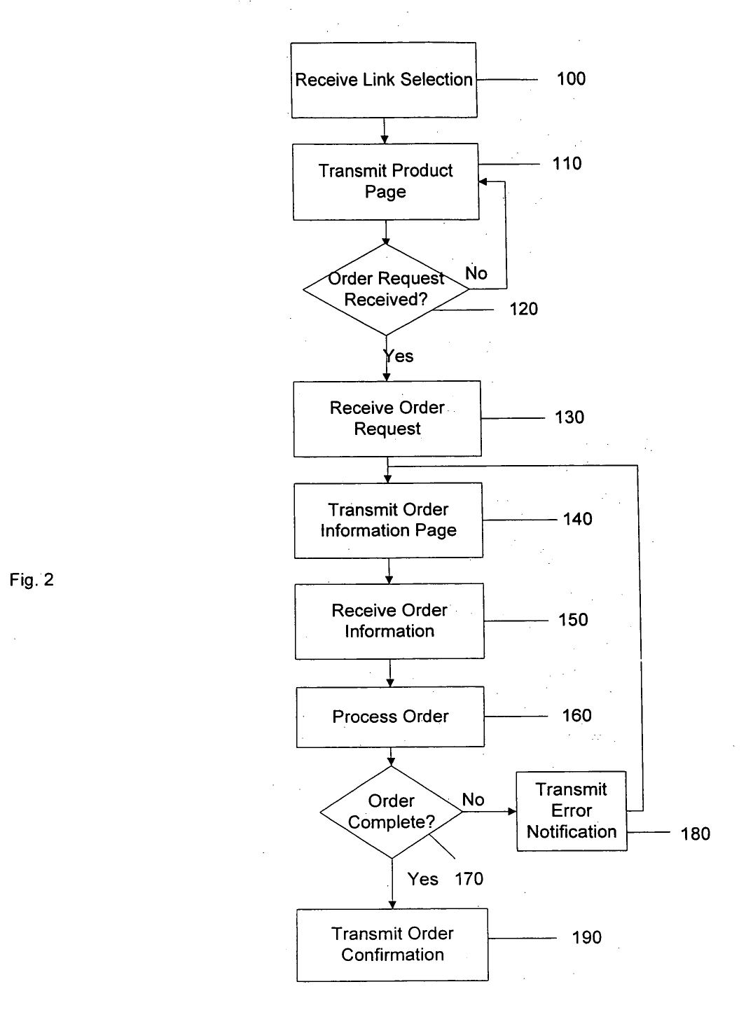

The editorial content may include links to product pages for products identified in the editorial content. The editorial content provider or a product supplier web site may present the product pages to the user. The product pages may enable the user to submit an order for a product associated with a particular link. FIG. 2 illustrates a method for ordering a product identified in editorial content according to one embodiment of the present invention.

A user may select a link for a particular product identified in the editorial content. A server associated with a product page for that product may receive the link selection in step 100. The server may be the server for the editorial content provider or a product supplier web site such as, for example, Buy.Com. The server transmits the product page to the user in step 1 10. The product page may provide a description of the product, enable the user to place an order for the product, or both. A determination is made whether the user has submitted an order request in step 120. If a determination is made that the user has not submitted an order request, the product page is transmitted to the user in step 1 10. If a determination is made that the user has submitted an order request, the server in step 130 receives the order request.

The server may then transmit an order information page to the user in step 140. The order information page may request, for example, the user's name, billing address, shipping address, payment method, method of delivery, etc. The server in step 150 receives the order information. The server may then process the order in step 160. This may include, for example, verifying the user's name and address and processing payment. A determination is made regarding whether the order was processed completely in step 170. If a determination is made that the order is not complete, an error notification that may include a description of the error is transmitted to the user. The order information page may then be transmitted to the user in step 140. If a determination is made that the order has been processed completely, an order confirmation may be transmitted to the user in step 170.

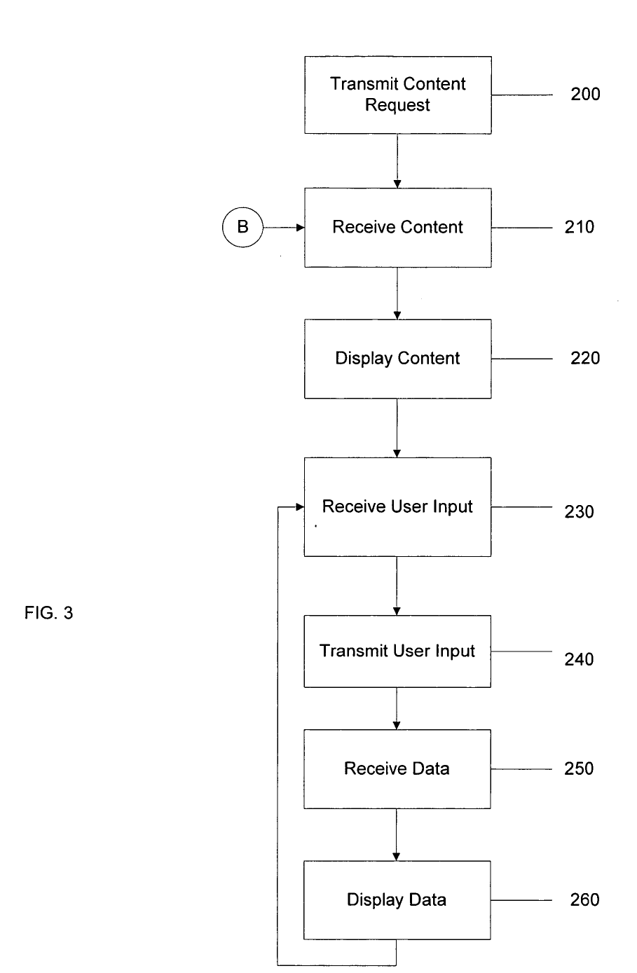

FIG. 3 illustrates operation of client software according to one embodiment of the invention. A user may use a client device to transmit an editorial content request to a server in step 200. The client receives the editorial content in step 210 and displays the content in step 220. The editorial content may be displayed using, for example, a conventional computer or laptop monitor, personal digital assistant or mobile phone screen, television or other display device. The client may receive user input in step 230. The user input may be, for example, a navigation request. The navigation request may be a request to display a next page, previous page or specific page of the editorial content. The client may transmit the user input to the server in step 240. The client receives data that satisfies the user input in step 250 and displays the data in step 260. If the user desires to navigate further through the editorial content, user input relating to the desired navigation maybe received in step 230.

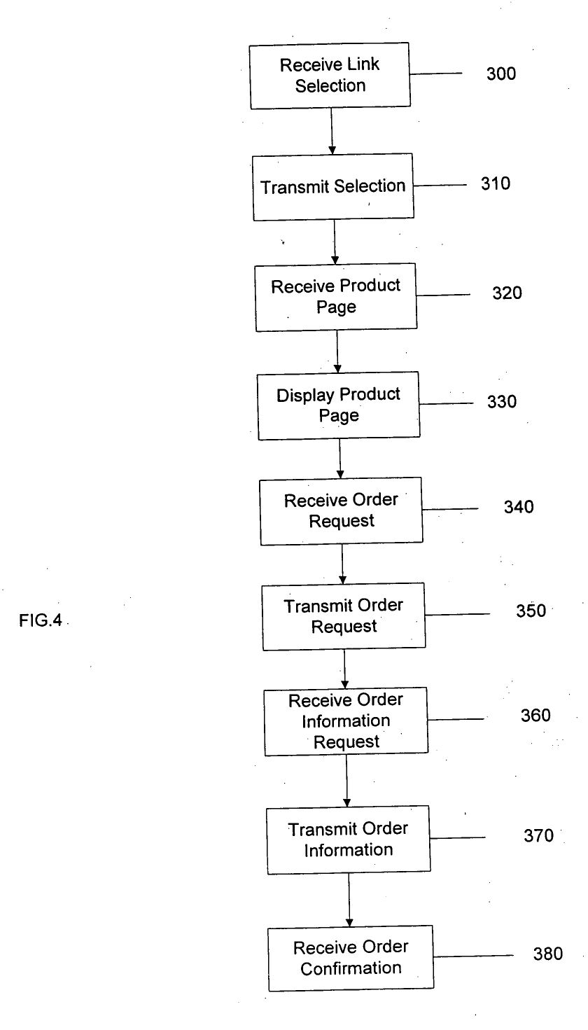

FIG. 4 illustrates operation of client software for ordering a product using an editorial content provider according to one embodiment of the invention. A client device may receive a product link selection from a user in step 300. The client device transmits the product link selection to a server in step 310. The server may be the server of the editorial content provider or a product supplier. The client device in step 320 receives a product page. The client device displays the product page on a display device in step 330. The client device may receive a product order request from the user in step 340 and transmit the order request to the server in step 350. An order information request maybe received by the client device in step 360. The order information request may request product ordering information such as, for example, the user's name, address, and billing information. The order information is transmitted to the server (or possibly a third-party server) in step 370 for processing the order. The client device may receive an order confirmation or error notification in step 380 depending on whether the order was processed completely.

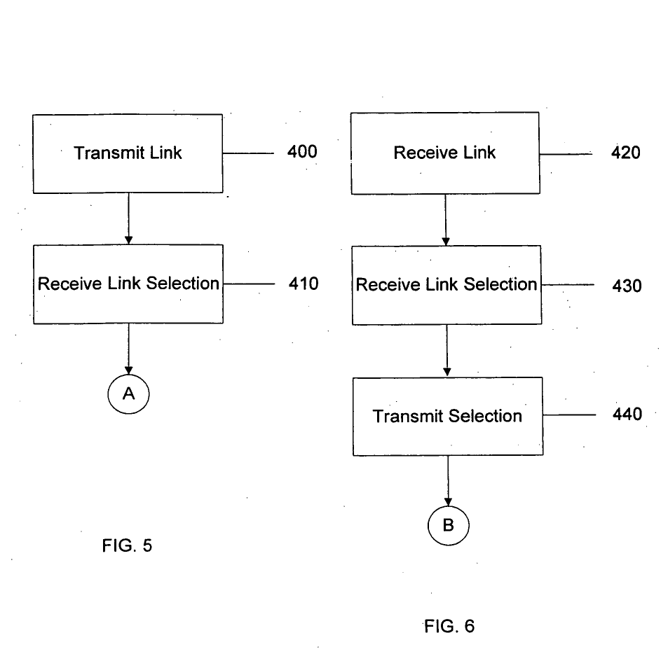

FIG. 5 illustrates a method of presenting a user with editorial content according to one embodiment of the invention. A server may transmit a link to the editorial content to a user in step 400. The link may be presented in, for example, an electronic mail message. The server may receive a user's selection of the link in step 410. The editorial content may then be presented to the user beginning with step 30 as described with reference to FIG. 1.

FIG. 6 illustrates operation of client software of presenting a user with editorial content according to one embodiment of the invention. A client device may receive a link to the editorial content in step 420. Preferably, the link is presented in an electronic mail message. The client device receives a user's selection of the link in step 430. The selection is transmitted to a server of the editorial content provider. The editorial content may then be presented to the user beginning with step 210 as described with reference to FIG. 3.

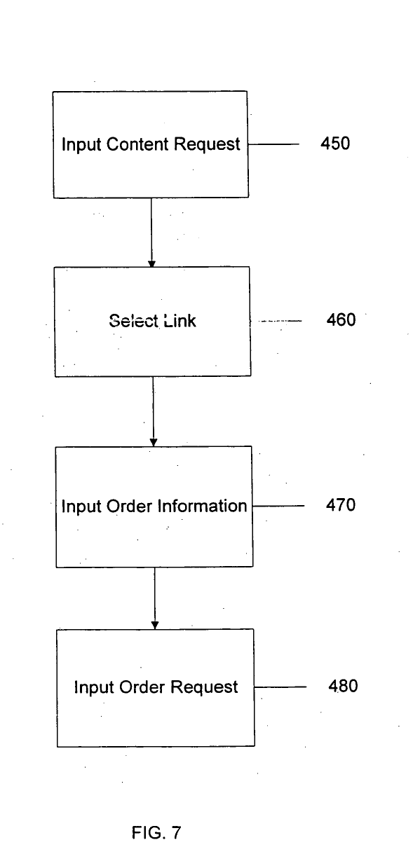

FIG. 7 illustrates user activity associated with ordering a product using an editorial content provider according to one embodiment of the invention. A user first inputs a request for editorial content in step 450. The user may then select a product link associated with a product identified in the editorial content in step 460. Upon receiving an order information page, the user may input any order information requested in step 470. The user may then submit an order request for the product in step 480. In this manner, the user is presented with an option to select a product for purchase directly from an editorial content provider that identifies the product. The user is not required to access another web site and search for the product desired to be purchased. This method combines editorial content with a shopping experience.

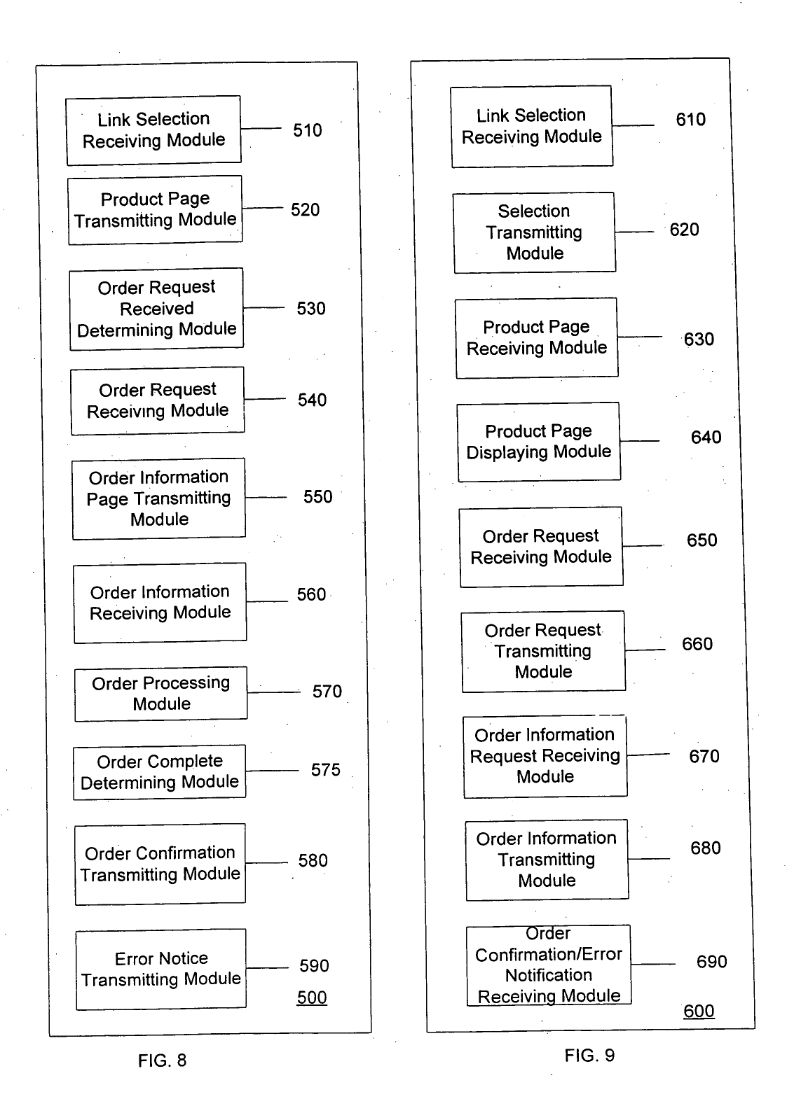

FIG. 8 illustrates a server system 500 for ordering a product identified in editorial content according to one embodiment of the present invention. The server system 500 may include a link selection receiving module 510, product page transmitting module 520, order request receiving determining module 530, order request receiving module 540, order information page transmitting module 550, order information receiving module 560, order processing module 570, order complete determining module 575, error notification transmitting module 580, and order confirmation transmitting module 590. A user may select a link for a particular product identified in the editorial content. The user may select the link using any known mechanism such as, for example, a conventional computer keyboard or mouse, touch-screen, light pen, voice recognition software or other input mechanism.

A link selection receiving module 510 associated with a product page for that product may receive the link selection. The product page transmitting module 520 transmits the product page to the user. The product page may provide a description of the product, enable the user to place an order for the product, or both. The order request received determining module determines whether the user has submitted an order request. If a determination is made that the user has not submitted an order request, the product page transmitting module 530 transmits the product page to the user. If a determination is made that the user has submitted an order request, the order request receiving module 540 receives the order request.

The order information page transmitting module 550 may then transmit an order information page to the user. The order information page may request, for example, the user's name, billing address, shipping address, payment method, method of delivery, etc. The order information receiving module 560 receives the order information. The order processing module 570 may then process the order. The order complete determining module 575 determines whether the order was processed completely. If a determination is made that the order is not complete, an error notification that may include a description of the error is transmitted to the user using the error notification transmitting module 580. The order-information page may then be transmitted to the user using the order information page transmitting module 550. If a determination is made that the order has been processed completely, an order confirmation may be transmitted to the user using the order confirmation transmitting module 590.

FIG. 9 illustrates client software system 600 for ordering a product using an editorial content provider according to one embodiment of the invention. The client software may include, for example, a link selection receiving module 610, selection transmitting module 620, product page receiving module 630, product page displaying module 640, order request receiving module 650, order request transmitting module 660, order information request receiving module 670, order information transmitting module 680, and order confirmation/error notification receiving module 690.

A client device may receive a product link selection using the link selection receiving module 610. The client device transmits the product link selection to a server using the selection transmitting module 620. The server may be the server of the editorial content provider or a product supplier. The client device receives a product page using the product page receiving module 630. The product page is displayed on a display device using the product page displaying module 640. A product order request may be received from the user using order request receiving module 650. The order request may then be transmitted to the server using order request transmitting module 660. An order information request may be received by the client device using order information request receiving module 670. The order information request may request product ordering information such as, for example, the user's name, address, and billing information. The order information is transmitted to the server (or possibly a third-party server) for processing the order using order information transmitting module 680. The client device may receive an order confirmation or error notification depending on whether the order was processed completely using the order confirmation/error notification receiving module 690.

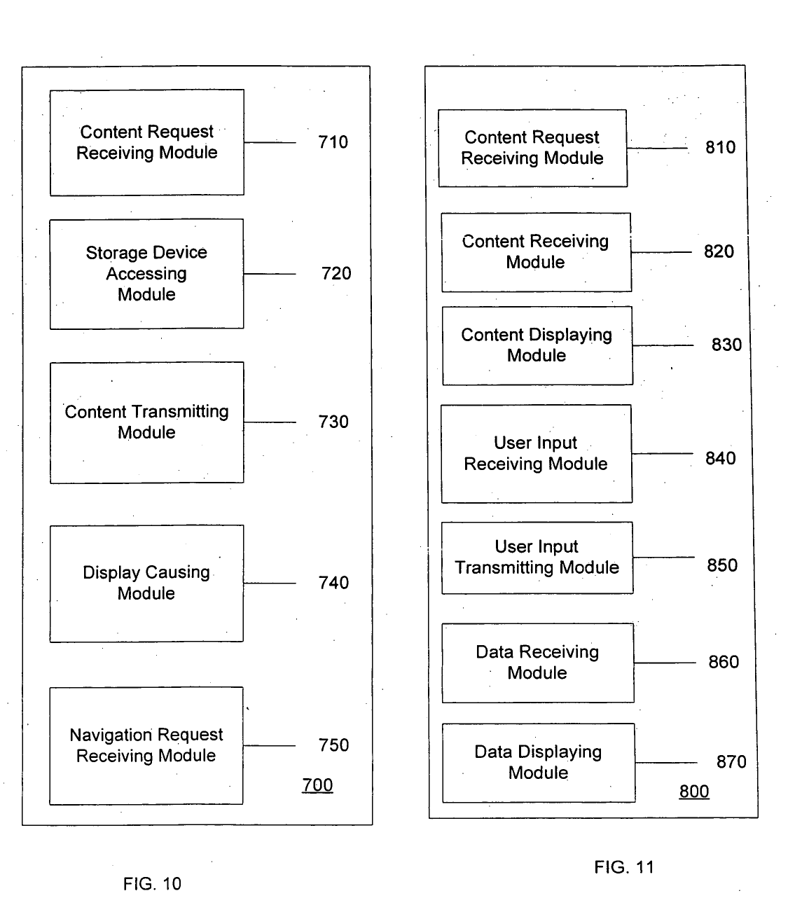

FIG. 10 illustrates a server system 700 for ordering a product using an editorial content provider according to one embodiment of the present invention. The server system may include a content request receiving module 710, storage device accessing module 720, content transmitting module 730, display causing module 740, and navigation request receiving module 750. The content request receiving module 710 may receive a request for editorial content from a device operated by a user. The storage device accessing module 720 accesses a storage device that stores the editorial content requested. The content transmitting module 730 then transmits the editorial content to the user's device. The display causing module 740 may cause the editorial content to be displayed on the user's device.

The display may include one or more navigation controls that enable the user to navigate the editorial content. The navigation request receiving module 750 may receive a navigation request from the user. The navigation request may cause the content transmitting module 730 to transmit particular editorial content that satisfies the navigation request. Upon receiving the navigation request, the storage device accessing module 720 may access the storage device storing the editorial content. The editorial content satisfying the navigation request may then be transmitted to the user using the content transmitting module 730.

FIG. 11 illustrates client software system 800 for displaying editorial content according to one embodiment of the invention. The system 800 may include a content request receiving module 810, content receiving module 820, content displaying module 830, user input receiving module 840, user input transmitting module 850, data receiving module 860, and data displaying module 870. A user may use a client device to transmit an editorial content request to a server using the content request receiving module 810. The client receives the editorial content using the content receiving module 820 and displays the content using the content displaying module 830. The client may receive user input using user input receiving module 840. The user input may be, for example, a navigation request. The navigation request may be a request to display a next page, previous page or specific page of the editorial content. The client may transmit the user input to the server using the user input transmitting module 850. The client receives data that satisfies the user input using the data receiving module 860 and displays the data using the data displaying module 870. If the user desires to navigate further through the editorial content, user input relating to the desired navigation may be received again using user input receiving module 840.

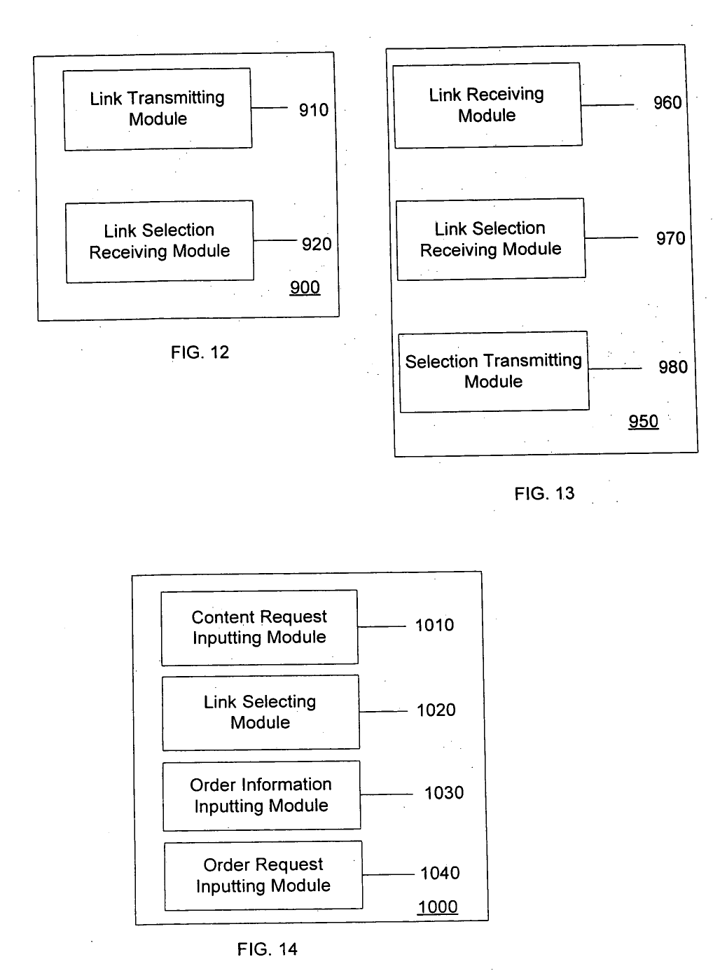

FIG. 12 illustrates a server system 900 for presenting a user with editorial content according to one embodiment of the invention. The server system 900 may include a link transmitting module 910 and a link selection module 920. The server system may transmit a link to the editorial content to a user using a link transmitting module 910. The link may be presented in, for example, an electronic mail message. The server system 900 may receive a user's selection of the link using the link selection receiving module 920. The editorial content may then be presented to the user using a system 800 as described with reference to FIG. 11 and beginning with step 30 as described with reference to FIG. 1.

FIG. 13 illustrates a client software system 950 for presenting a user with editorial content according to one embodiment of the invention. The system 950 may include a link receiving module 960, link selection receiving module 970, and a selection transmitting module 980. A client device may receive a link to the editorial content using the link receiving module 960. Preferably, the link is presented in an electronic mail message. The client device receives a user's selection of the link using the link selection receiving module 970. The selection is transmitted to a server of the editorial content provider using selection transmitting module 980. The editorial content may then be presented to the user using the system 800 described with reference to FIG. 11 and beginning with step 210 as described with reference to FIG. 3.

FIG. 14 illustrates a system 1000 associated with ordering a product using an editorial content provider according to one embodiment of the invention. The system may include a content request inputting module 1010, link selecting module 1020, order information inputting module 1030, and order request inputting module 1040. A user first inputs a request for editorial content using content request inputting module 1010. The user may then select a product link associated with a product identified in the editorial content using the link selecting module 1020. Upon receiving an order information page, the user may input any order information requested using the order information inputting module 1030. The user may then submit an order request for the product using the order request inputting module 1040.

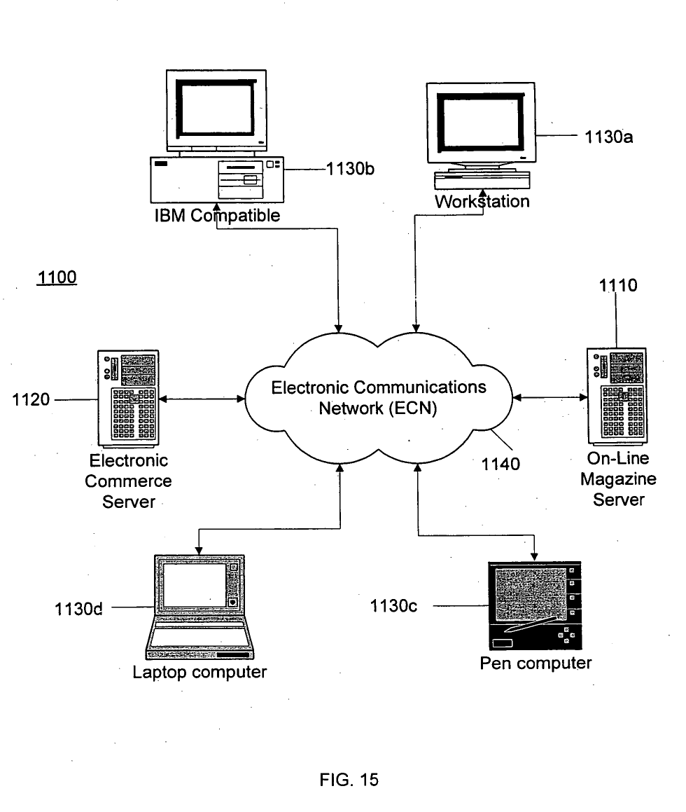

FIG. 15 illustrates a client/server system 1100 that may be used to implement the present invention according to one embodiment. The system 1100 may include an on-line magazine server 1110, electronic commerce server 1120, and client devices 1130a-1130d that may be in communication over an electronic communications network (ECN) 1140. The client devices 1130a-1130d may be, for example, a desktop or laptop computer, workstation, pen-based computer, personal digital assistant (PDA), mobile phone or any other web-enabled device. The ECN 1140 may be any type of network such as the Internet, local area network (LAN), personal area network (PAN), metropolitan area network (MAN), or wide area network (WAN). All or portions of the ECN 1140 may be wire or wireless.

The client devices 1130a-1130d may communicate with the on-line magazine server 1110 to enable a user to browse an on-line magazine (as described above) presented by the on-line magazine server 1110. The on-line magazine may include a plurality of hypertext links to products identified in the on-line magazine. The links may be in articles, advertisements, table of contents or other location. After selecting a link, the user is preferably presented with a product page associated with the link by the electronic commerce server 1120. The product page may include a description of the product and a link to a purchase page or purchase page information that enables the user to submit an order to purchase the product as described above.

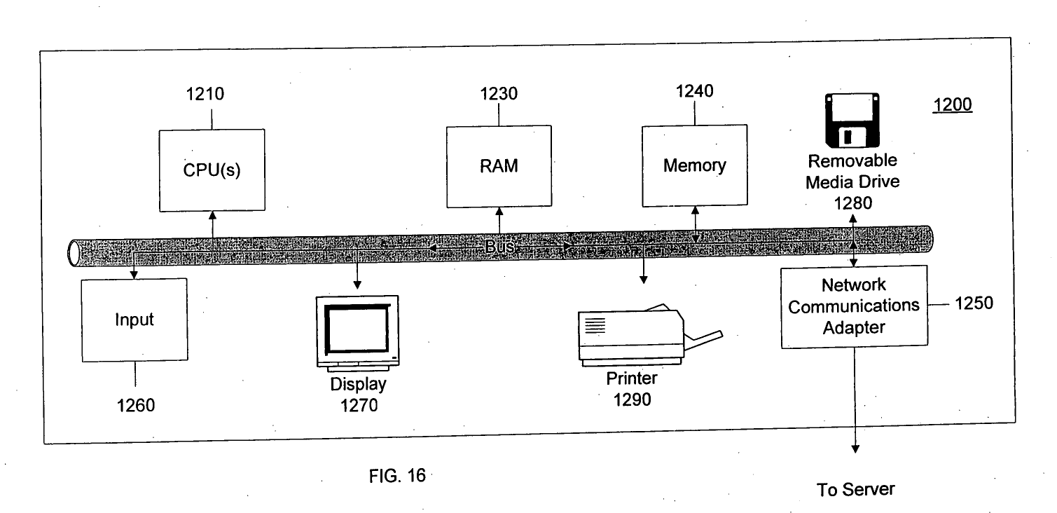

As illustrated in FIG. 16, a typical client device 1200 includes a central processing unit 1210 (CPU). The CPU 1210 is connected through a bus 1220 to, among other things, volatile memory 1230 (also called RAM or random access memory), non-volatile memory 1240 (such as disk drives, CD-ROMs or data tapes), a network communications adapter 1250 (such as an Ethernet card), an input means 1260, such as a keyboard and/or a pointing or point-and-click device (such as a mouse, light pen, touch screen, touch pad), an output device 1270, such as a video display screen and/or an audio speaker, a removable media drive 1280, such as a floppy disk drive, CD-ROM drive, PCMIA port, CD-WORM drive or data tape drive, and a printer 1290. The client system 1200 operates client software 1245 for use with the present invention. The client software 1245 is shown graphically as being stored in non-volatile memory 1240. However, it should be understood that the client software may also be stored in transportable media read by removable media drive 1280. All, or portions of the client software 1245 may also be loaded into volatile memory 1230 (RAM), for example during operation. Exemplary transportable media implementing the client software (which may be in any form, such as source code, compiled or binary versions) include floppy disks, magnetic tape, and optical disks. In a preferred embodiment, a client device is a portable computer and the electronic communications network is the Internet or an on-line service network.

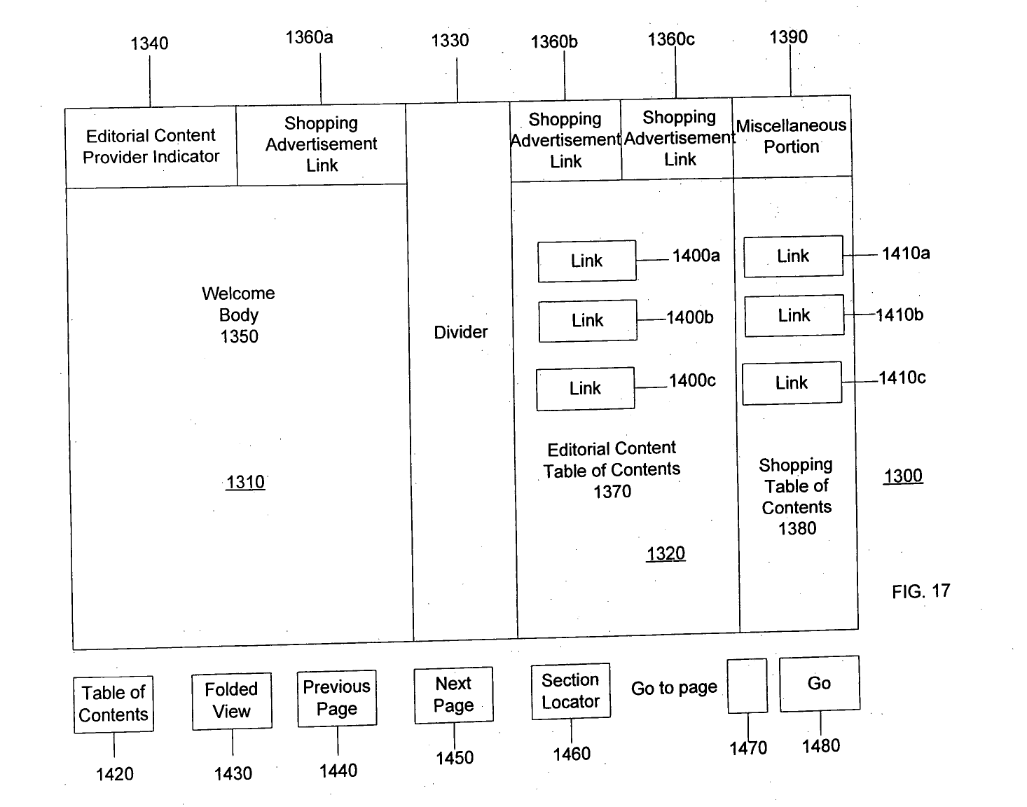

FIG. 17 illustrates a welcome display 1300 of a client system according to one embodiment of the present invention. The welcome display 1300 may include a left portion 1310 and a right portion 1320 separated by a divider 1330. The left portion 1310 represents a left side of an open printed publication (such as a book, magazine, catalog or newspaper) and the right portion 1320 represents the right side of the open printed publication. The divider 1330 represents a seam, fold, bound portion or other manner of enabling a printed publication to be read. The left portion 1310 may include an editorial content provider indicator 1340, welcome body 1350, and shopping advertisement link 1330a. The right portion 1320 may include an editorial content table of contents 1370, shopping table of contents 1380, shopping advertisement links 1330b-1330c, and a miscellaneous portion 1390.

The editorial content table of contents 1370 may include a plurality of links 1400a-1400c to features, articles or other portions of editorial content. The links enable a reader to cause a display associated with a particular link to be presented to the reader. The shopping table of contents 1380 may also include links 1410a-1410c. The links 410a-1410c may cause particular shopping category sections associated with the links to be presented to the reader. For example, the shopping categories may include music, electronics, and sports. By selecting one of the links 1410a-1410c, the reader may be presented with one or more pages associated with that shopping category.

The miscellaneous portion 1390 may be used for any type of display. For example, the miscellaneous portion 1390 may be another shopping advertisement link, a special notice, a section heading or any other type of display.

The welcome display 1300 may also include navigation and view controls presented, for example, along a lower portion of the display. The navigation and view controls may include an editorial content table of contents link 1420, fold-over view option 1430, previous page selector 1440, next page selector 1450, section locator 1460, Go to page receiving field 1470, and go selector 1480. The navigation and view controls are preferably presented on each page of the editorial content.

The editorial content table of contents link 1420 maybe a hypertext link to the welcome display 1300. This enables a reader to quickly be presented with the welcome display 1300 regardless of which page of the editorial content the reader is viewing. The fold-over view option 1430 enables the reader to present the display in a folded view format as described above. The next page and previous page selectors 1440, 1450, Go to page receiving field 1470, and go selector 1480 enable the reader to browse the editorial content in a similar manner as in a printed publication and as described above.

The section locator 1460 enables the reader to quickly be presented with a display corresponding to a selected section. The section locator 1460 may operate in a manner as described above.

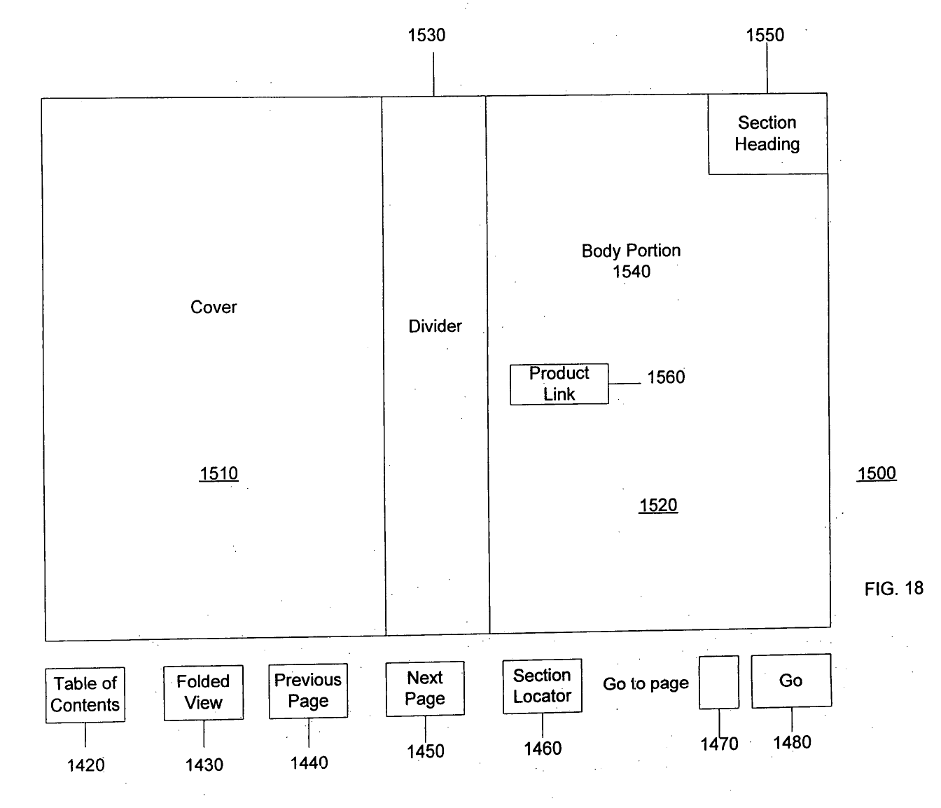

FIG. 18 illustrates a front page display 1500 of a client system according to one embodiment of the present invention. The front page display 1500 may include a cover 1510 and a first page 1520 separated by a divider 1530. The front page display 1500 preferably simulates a cover and first page of a printed publication. The front page 1520 may include a body portion 1540 and section heading 1550. The body portion 1540 preferably includes one or more product links 1560. The product links 1560 preferably are hypertext links to product pages that enable a reader of the editorial content to submit an order for the product. The reader may submit an order for a product as described above. The section heading 1550 may be an identifier indicating which section of the editorial content the reader is viewing. The front page display 1500 may also include the navigation and view controls 1420-1480 as described with reference to FIG. 17.

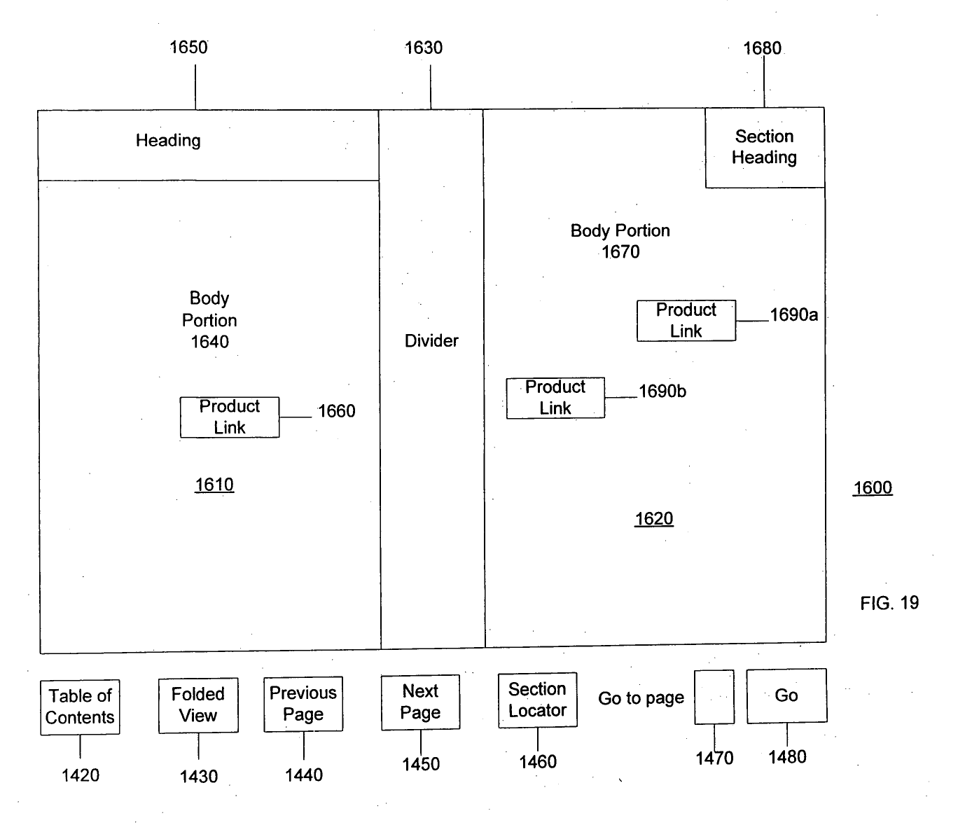

FIG. 19 illustrates an inside page display 1600 of a client system according to one embodiment of the present invention. The inside page display 1600 may include a first page 1610 and second page 1620 separated by a divider 1630. The inside page display 1600 is preferably presented in a format that simulates an open publication such that a reader viewing the display is provided with a reading experience that is similar to an experience of reading a print version. The first page 1610 may include a body portion 1640 and heading 1650. The body portion 1640 may include one or more product links 1660 as described above. The heading 1650 may provide any desired information such as, for example, a name of an editorial content provider providing editorial content that the reader is viewing.

The second page 1620 may include a body portion 1670 and section heading 1680. The body portion 1670 may include product links 1690a-1690b. The product links 1690a- 1690b may operate in a manner as described above. The section heading 1680 maybe an indicator identifying a section name of the portion of the editorial content that the reader is viewing. The inside page display 1600 may include the navigation and view controls 1420-1480 as described above with reference to FIG. 17.

Thus, it is seen that a system and method for providing on-line editorial content that includes links to product pages are provided. One skilled in the art will appreciate that the present invention can be practiced by other than the preferred embodiments which are presented in this description for purposes of illustration and not of limitation, and the present invention is limited only by the claims that follow. It is noted that equivalents for the particular embodiments discussed in this description may practice the invention as well.

1. An on-line magazine comprising:
reading content in a format of a printed publication; and
links to product pages.

2. The on-line magazine of claim 1 wherein at least one product page link is provided within at least one article of the on-line magazine.

3. The on-line magazine of claim 1 further comprising at least one of:
magazine page navigation controls that enable a reader to navigate the on-line magazine, magazine table of contents, magazine page numbers, section identifiers, section locators, page locators, page divider, and shopping table of contents.

4. The on-line magazine of claim 3 wherein the at least one of the magazine table of contents and the shopping table of contents include at least one of an alphanumeric locator and a user selectable link that causes the reading content associated with the user selectable link to be displayed.

5. The on-line magazine of claim 3 wherein the section locators are selected from the group consisting of a pull-down menu, radio buttons, and hypertext links.

6. A method of ordering a product using an editorial content provider comprising:
transmitting editorial content to a user, wherein the editorial content includes a user selectable link to a product identified in the editorial content; and
transmitting a product page associated with the user selectable link to the user.

7. The method of claim 6 wherein the editorial content comprises at least one of an electronic magazine and a newspaper that includes at least one of page numbers associated with the at least one of an electronic magazine and a newspaper, page navigation controls associated with the at least one of an electronic magazine and a newspaper, table of contents, shopping table of contents, section identifiers, section locators, page divider, and page locators.

8. The method of claim 7 wherein at least one of the table of contents and the shopping table of contents include at least one of an alphanumeric locator and a user selectable link that causes the editorial content associated with the user selectable link to be displayed.

9. The method of claim 6 further comprising:
enabling the user to order the product, wherein the product is ordered using a server of a product provider.

10. The method of claim 6 wherein the transmitting editorial content to a user includes:
transmitting an electronic mail message to the user, wherein the electronic mail message includes an editorial content link to the editorial content.

11. A method of ordering a product using an editorial content provider comprising:
receiving the editorial content from a first server, wherein the editorial content includes a user selectable link to a product identified in the editorial content;
displaying the editorial content and the user selectable link to a user;
receiving user input regarding editorial content navigation;
transmitting a user input request to a second server based on the user input;
receiving data related to the user input request; and
displaying the data to the user.

12. The method of claim 11 further comprising:
transmitting at least one of a next page request, previous page request, and a specific page number request to the first server; and
receiving one of the next page request, previous page request, and specific page request from the first server.

13. The method of claim 11 further comprising:
receiving a selection of the user selectable link; and
transmitting the selection to the second server;
receiving a product page associated with the user selectable link.

14. The method of claim 11 further comprising:
receiving an electronic mail message, wherein the electronic mail message includes an editorial content link to the editorial content.

15. The method of claim 11 wherein the editorial content is presented as one of an electronic magazine and a newspaper.

16. A system for ordering a product using an editorial content provider comprising:
an editorial content transmitting module that transmits editorial content to a user, wherein the editorial content includes a user selectable link to a product identified in the editorial content; and
a product transmitting page that transmits a product page associated with the user selectable link to the user.

17. The system for claim 16 wherein the editorial content is presented as one of an electronic magazine and a newspaper.

18. The system for claim 17 wherein the electronic magazine includes at least one of magazine page numbers, magazine page navigation controls, table of contents, shopping table of contents, section identifiers, section locators, page divider, and page locators.

19. The system for claim 18 wherein at least one of the table of contents and the shopping table of contents include at least one of an alphanumeric locator and a user selectable link that causes the editorial content associated with the user selectable link to be displayed.

20. The system for claim 16 wherein the product is ordered using a server of a product provider.

21. The system for claim 16 further comprising:
an editorial content request receiving module that receives a request for editorial content from a user; and
an accessing module that accesses an electronic storage device that includes the editorial content requested.

22. The system for claim 16 further comprising:
a display causing module that causes the editorial content to be displayed to the user.

23. The system for claim 16 further comprising:
a product order enabling module that enables the user to order the product.

24. The system for claim 16 further comprising:
an electronic mail message transmitting module that transmits an electronic mail message to the user, wherein the electronic mail message includes an editorial content link to the editorial content.

25. A system for ordering a product using an editorial content provider comprising:
an editorial content receiving module that receives editorial content from a first server, wherein the editorial content includes a user selectable link to a product identified in the editorial content;
an editorial content displaying module that displays the editorial content and the user selectable link to a user;
a user input receiving module that receives user input regarding editorial content navigation;
a user input request transmitting module that transmits a user input request to a second server based on the user input;
a data receiving module that receives data related to the user input request; and
a data displaying module that displays the data to the user.

26. The system for claim 25 further comprising:
a transmitting module that transmits at least one of a next page request, previous page request, and a specific page request to the first server; and
a receiving module that receives the at least one of a next page request, previous page request, and a specific page request from the first server.

27. The system for claim 25 further comprising:
a selection receiving module that receives a selection of the user selectable link;
a selection transmitting module that transmits the selection to the second server; and
a product page receiving module that receives a product page associated with the user selectable link.

28. The system for claim 25 further comprising:
an editorial content request transmitting module that transmits an editorial content request to the first server.

29. The system for claim 25 further comprising:
an electronic mail message receiving module that receives an electronic mail message, wherein the electronic mail message includes an editorial content link to the editorial content.

30. The system for claim 25 wherein the editorial content is presented as at least one of an electronic magazine and a newspaper.
